(19) United States
(12) Patent Application Publication
(10) Pub. No.: US 2007/0175988 A1
(43) Pub. Date: Aug. 2, 2007

(54) Method, system, and computer program product for providing self-checkout services

(75) Inventor: Scott A. Martin, Cary, NC (US)

Correspondence Address: CANTOR COLBURN LLP - IBM RESEARCH TRIANGLE PARK, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/345,063

(22) Filed: Feb. 1, 2006

(51) Int. Cl. G06K 15/00

(52) U.S. Cl. 235/383

(57) ABSTRACT

A method, system, and computer program product for providing self-checkout services is provided. The method includes activating a detection element within an item repository in response to the initiation of a transaction, the detection element monitoring the presence of personal items placed in the item repository. The transaction includes performing a purchase transaction that includes processing items for purchase. Upon completion of the purchase transaction, the method determines if any personal items remain in the item repository. If so, the transaction includes recursively presenting a reminder message to the customer to remove the personal items and waiting a specified period of time while monitoring for removal of the personal items until each of the personal items have been removed, a total specified period of time has elapsed, or a specified number of reminder messages presented has been reached. If each of the personal items has been removed from the item repository, the method includes ending the transaction.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to electronic transactions and, in particular, to a method, system, and computer program product for providing self-checkout services at a point of sale locations.

2. Description of Background

In order to stay competitive in today's global marketplace, brick-and-mortal establishments are becoming more aggressive in finding new ways to provide value added services to their customers. For example, in the food industry, many establishments now offer automated self-checkout registers that can reduce the amount of time customers are required to wait in lines, and also provide reduced overhead with respect to staffing, scheduling, and related administrative costs. Self-checkout systems enable customers to scan and pay for their items completing the purchase transaction without the assistance of a human cashier.

One of the disadvantages associated with these self-checkout systems (and even the standard human-assisted checkout systems) is that many customers often leave behind personal items that were placed on or near the self-checkout system while handling items being purchased (e.g., removing the goods from a shopping cart and placing them on a counter or conveyer belt). Personal items, such as purses, wallets, car keys, umbrellas, clothing, etc., are often left behind once the purchase transaction has been completed.

What is needed, therefore, is a way to eliminate or at least minimize the occurrence of forgotten items at the self-checkout system.

### SUMMARY OF THE INVENTION

The shortcomings of the prior art are overcome and additional advantages are provided through the provision of a method for providing self-checkout services to customers of an establishment. The method includes activating a detection element within an item repository in response to the initiation of a transaction, the detection element monitoring the presence of personal items placed in the item repository. The transaction includes performing a purchase transaction that includes processing items for purchase. Upon completion of the purchase transaction, the method determines if any personal items remain in the item repository. If so, the transaction includes recursively presenting a reminder message to the customer to remove the personal items and waiting a specified period of time while monitoring for removal of the personal items until each of the personal items have been removed, a total specified period of time has elapsed, or a specified number of reminder messages presented has been reached. If each of the personal items has been removed from the item repository, the method includes ending the transaction.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which enables users of a self-checkout system to receive reminder messages in the event a personal item is left in an item repository that temporarily stores personal items for users of the self-checkout system. The solution includes a detection device associated with the item repository that communicates a presence of personal items in the repository during a purchase transaction. The self-checkout system monitors the continued presence of the personal items and presents the reminder messages to the customers.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a system upon which the self-checkout services may be implemented in exemplary embodiments; and

FIG. 2 is a flow diagram describing a process for implementing the self-checkout services in exemplary embodiments.

The detailed description explains the preferred embodiments of the invention, together with advantages and features, by way of example with reference to the drawings.

### DETAILED DESCRIPTION OF THE INVENTION

In accordance with exemplary embodiments, a method, system, and computer program product for providing self-checkout services is provided. The self-checkout services enable users of a self-checkout system to receive reminder messages in the event a personal item is left in an item repository that temporarily stores personal items for users of the self-checkout system. The solution includes a detection device associated with the item repository that communicates a presence of personal items in the repository during a purchase transaction. The self-checkout system monitors the continued presence of the personal items and presents the reminder messages to the users.

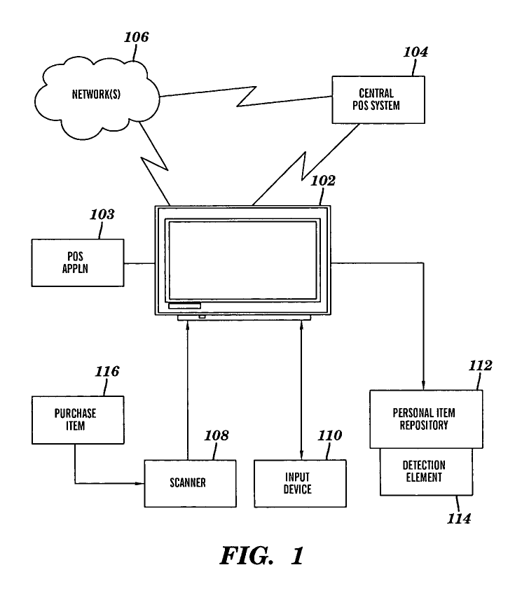

Turning now to FIG. 1, an exemplary system upon which the self-checkout services may be implemented in accordance with exemplary embodiments will now be described. The system of FIG. 1 includes a point-of-sale (POS) register 102 in communication with a central POS system 104 and one or more networks 106. POS register 102 includes a processor executing software, such as the POS application 103. POS register 102 includes a display monitor for presenting reminder messages to customers as will be described further herein. The monitor also provides purchase transaction information, such as itemized purchases and prices, a total costs associated with a purchase, and related purchase transaction information.

POS register 102 communicates over one or more networks 106 with network entities, such as financial institutions (not shown). Purchases are made via the POS register 102 whereby the POS register 102 facilitates electronic funds transfers over network(s) 106 between customer accounts for one or more financial institutions and the establishment that implements the POS register 102 (i.e., a vendor). For this purpose, POS register is communicatively coupled to network(s) 106.

POS register 102 is also communicatively coupled to central POS system 104, which represents a centralized processor for managing one or more POS registers (e.g., POS register 102) within the establishment. Central POS system 104 may also provide pricing information for purchase items scanned by scanner 108, whereby scanner 108 transmits Universal Product Code (UPC) information from a scanned purchase item to central-POS system 104, central POS system 104 searches a UPC database for the UPC information, and returns a price for the purchase item to the POS register 102. These and other functions may be performed by central POS system 104.

As shown in the system of FIG. 1, central POS system 104 may be directly coupled to POS register 102 (e.g., via cabling, wireless LAN, etc.), or may be indirectly coupled to POS register 102 via one or more network(s) 106 (e.g., where central POS system 104 is remotely located from the enterprise in which the POS register 102 is located.

Network(s) 106 may comprise any type of network, e.g., wireless or wireline or a combination thereof. Network(s) 106 may include, e.g., a local area network (LAN), wide area network (WAN), Internet, etc.

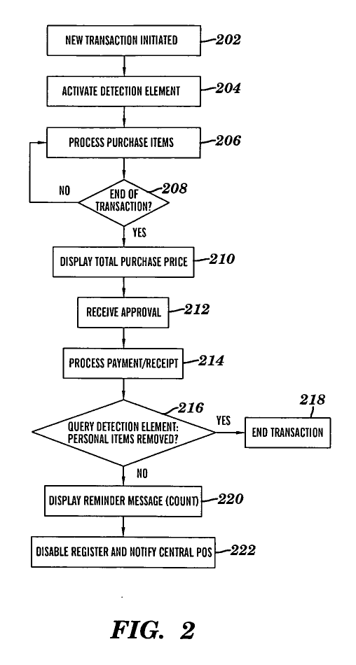

As indicated above, a POS application 103 is executing on the processor of POS register 102. POS application 103 facilitates the self-checkout services described herein and in further detail in FIG. 2.

In exemplary embodiments, the POS register 102 is also in communication with a scanner 108, input device 110, and personal item repository 112. Scanner 108 may be a Universal Product Code (UPC) scanner or other device capable of reading data from product items (e.g., purchase item 116). Scanner 108 may be a handheld instrument that is passed over the UPC on products or may be built into a counter or platform whereby products are passed over the scanner. Scanner 108 reads data from purchase items and transmits the data to the POS register 102 via, e.g., a wireless or wireline connection.

The personal item repository 112 (also referred to herein as item repository) may comprise a shelf, container, or similar storage element suitable for stowing personal items belonging to a user of the self-checkout system. Personal items may include a purse, wallet, umbrella, clothing, car keys, or other similar items typically carried by a customer visiting a retail or business enterprise. Personal item repository 112 is communicatively coupled to POS register 102 via wireless or wireline elements (e.g., serial cable, 802.11 technologies, etc.).

Personal item repository 112 includes a detection element 114. Detection element 114 may include a scale, sensor, or other instrument that captures information relating to personal items. In exemplary embodiments, the detection element 114 detects, at a minimum, the presence of any personal items in the item repository 112. Detection element 114 may also capture weight information or other measurements associated with the personal items.

Input device 110 may include a keypad device that enables a customer to enter account and payment information for processing by the POS register 102. For example, input device 110 may include a scanning element for reading a customer's credit or debit card including account number. The keypad device enables a customer to enter a personal identification number (PIN) if using a debit card. Input device 110 is communicatively coupled to POS register 102 via wireless or wireline elements (e.g., serial cable, 802.11 technologies, etc.).

Turning now to FIG. 2, a flow diagram describing a process for implementing the self-checkout services will now be described in accordance with exemplary embodiments.

At step 202, a new transaction at a self-checkout system (e.g., the checkout system of FIG. 1) is initiated. In exemplary embodiments, the transaction is initiated when a customer approaches the POS register 102 and enters account information into input device 110. Elements of the transaction described in FIG. 2 include processing a customer's account information (e.g., input device 110 and POS register 102), processing a purchase transaction, monitoring the presence of any personal items in the item repository 112, presenting notifications concerning the presence of the personal items in the repository 112, and disabling the POS register 102 if needed. The purchase transaction process includes activities directly related to the purchase of the items as described in FIG. 2.

At step 204, the detection element 114 is activated in response to the initiation of the new transaction. The activation may be implemented by sending a signal to the detection element 114 via the communications link between the POS register 102 and the personal item repository 112. Activating the detection element 114 causes the detection element 114 to begin monitoring the personal item repository 112 for any personal items that may be placed thereon. It will be appreciated that a customer may place personal items in the item repository 112 at any point in time during the transaction.

At step 206, the purchase transaction is processed. The purchase transaction includes scanning purchase items 116 via scanner 108, transmitting the scanned data to POS register 102 and central POS system 104 in order to look up pricing information for the purchase items 116 based, e.g., on the UPC data provided in the scan. The central POS system 104 returns the pricing information to the POS register 102 whereby the purchase product information and pricing information are displayed on the POS register 102 for the benefit of the customer.

At step 208, it is determined whether the purchase transaction is complete. The purchase transaction is complete when the customer has finished scanning the items for purchase and designated said completion via, e.g., selecting an option on the input device 110, which in turn, communicates the completed purchase to the POS register 102. If the purchase transaction is not complete, the process returns to step 206. Otherwise, the pricing information of the purchase items is totaled up and presented to the customer via the monitor or display element of POS register 102 at step 210.

The customer is prompted to approve or accept the purchase. At step 212, the approval for the purchase is received at the POS register 102 via, e.g., an option selected through the keypad of input device 110. Once approved, the purchase transaction is completed by processing the payment through the customer account information (e.g., via the networks 106 and financial institution of the customer account) and a receipt is generated and presented to the customer at step 214.

At step 216, it is determined whether the personal items have been removed from the item repository 112. As indicated above, the detection element continuously monitors the presence of any personal items in the repository 112 throughout the transaction. If the personal items have been removed as determined by the detection element 114, the transaction ends at step 218. Otherwise, a reminder message is generated and presented to the customer at step 220. The message may be any format, such as text, audio, video, or multi-media. The message is a reminder to the customer to remove the personal items from the item repository 112.

In accordance with exemplary embodiments, the POS application 103 waits a pre-defined period of time before sending subsequent reminder messages. The POS application 103 may be configured to send a set number of reminder messages while the detection element 114 continues to monitor a presence of the personal items and notify the POS application 103 of its status (e.g., whether or the personal items have been removed). Alternatively, the POS application 103 may be configured to present a designated number of reminder messages, each one followed by a wait period, as desired. Thus, if the POS application 103 is notified that the personal items have not been removed after a number of message attempts and/or a specified time period, the POS application 103 disables the POS register 102 at step 222 in order to prevent the occurrence of any further transactions until the personal items are removed from the repository 112.

The central POS system 104 is notified that the POS register has been disabled and that personal items have been left in the repository. By notifying the central POS system 104 of this issue, the personal items can be recovered quickly and returned to the customer before the customer leaves the establishment. This capability provides a value-added service to customers of the establishment in that it minimizes the risks associated with items being inadvertently left in a store (e.g., loss or theft) and prevents the customers from having to return to the store or retrace their actions in order to recover their personal items.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for providing self-checkout services, comprising:
activating a detection element within an item repository in response to initiation of a transaction, the detection element monitoring a presence of personal items placed in the item repository, the transaction including:
performing a purchase transaction that includes processing items for purchase; and
upon completion of the purchase transaction, performing:
determining if any of the personal items remain in the item repository;
if any of the personal items remain in the item repository, recursively presenting a reminder message to remove the personal items and waiting a specified period of time while monitoring for removal of the personal items until an occurrence of at least one of:
each of the personal items is removed from the item repository;
a total specified period of time has elapsed; and
a specified number of reminder messages presented has been reached; and
if each of the personal items have been removed from the item repository, ending the transaction.

2. The method of claim 1, further comprising:
disabling a register associated with the transaction when any of the personal items remain in the item repository and upon the occurrence of at least one of the total specified period of time has elapsed and the specified number of reminder messages presented has been reached; and
notifying a central point of sale system that personal items have been left in the item repository.

3. The method of claim 1, wherein the detection element is a scale.

4. The method of claim 1, wherein the detection element is a sensor.

5. The method of claim 1, wherein the reminder message is presented in a format including at least one of text, audio, video, and multi-media.

6. A system for providing self-checkout services, comprising:
a point-of-sale register;
an item repository in communication with the point-of-sale register, the item repository including a detection element for monitoring a presence of personal items placed in the item repository; and
a point-of-sale application executing on point-of-sale register, the point-of-sale application implementing:
activating the detection element in response to initiation of a transaction, the transaction including:
performing a purchase transaction that includes processing items for purchase; and
upon completion of the purchase transaction, performing:
determining if any of the personal items remain in the item repository;
if any of the personal items remain in the item repository, recursively presenting a reminder message to remove the personal items and waiting a specified period of time while monitoring for removal of the personal items until an occurrence of at least one of:
each of the personal items are removed from the item repository;
a total specified period of time has elapsed; and
a specified number of reminder messages presented has been reached; and
if each of the personal items have been removed from the item repository, ending the transaction.

7. The system of claim 6, wherein the point-of-sale application further implements:
disabling a register associated with the transaction when any of the personal items remain in the item repository and upon the occurrence of at least one of the total specified period of time has elapsed and the specified number of reminder messages presented has been reached; and
notifying a central point of sale system that personal items have been left in the item repository.

8. The system of claim 6, wherein the detection element is a scale.

9. The system of claim 6, wherein the detection element is a sensor.

10. The system of claim 6, wherein the reminder message is presented in a format including at least one of text, audio, video, and multi-media.

11. A computer program product for implementing self-checkout services, the computer program product including instructions for implementing a method, comprising:
activating a detection element within an item repository in response to initiation of a transaction, the detection element monitoring a presence of personal items placed in the item repository, the transaction including:
performing a purchase transaction that includes processing items for purchase; and
upon completion of the purchase transaction, performing:
determining if any of the personal items remain in the item repository;
if any of the personal items remain in the item repository, recursively presenting a reminder message to remove the personal items and waiting a specified period of time while monitoring for removal of the personal items until an occurrence of at least one of:
each of the personal items is removed from the item repository;
a total specified period of time has elapsed; and
a specified number of reminder messages presented has been reached; and
if each of the personal items have been removed from the item repository, ending the transaction.

12. The computer program product of claim 11, further comprising instructions for implementing:
disabling a register associated with the transaction when any of the personal items remain in the item repository and upon the occurrence of at least one of the total specified period of time has elapsed and the specified number of reminder messages presented has been reached; and
notifying a central point of sale system that personal items have been left in the item repository.

13. The computer program product of claim 11, wherein the detection element is a scale.

14. The computer program product of claim 11, wherein the detection element is a sensor.

15. The computer program product of claim 11, wherein the reminder message is presented in a format including at least one of text, audio, video, and multi-media.
